(19) United States
(12) Patent Application Publication
(10) Pub. No.: US 2005/0253874 A1
(43) Pub. Date: Nov. 17, 2005

(54) Report customization and viewer

(75) Inventors: Arun Lal, Kirkland, WA (US); Peter Birkedal Hansen, Seattle, WA (US); Sumeet Shrivastava, Kirkland, WA (US); Joern Lindhard Mortensen, Kirkland, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/890,932

(22) Filed: Jul. 14, 2004

Related U.S. Application Data
(60) Provisional application No. 60/570,670, filed on May 13, 2004.

(51) Int. Cl. G09G 5/00

(52) U.S. Cl. 345/661

(57) ABSTRACT

A computer-implemented method for presenting information to a user is provided. The method includes displaying a report having a plurality of groups in a report display. Each group has a plurality of elements. A modification pane is displayed proximate the report display. The modification pane including a plurality of modification options. A selection is received that is associated with a selected group and a selected modification option. The method further includes changing how each of the plurality of elements in the selected group is displayed based on the selection.

### CROSS REFERENCE TO RELATED APPLICATION

The present application is based on and claims the benefit of U.S. provisional patent application Ser. No. 60/570,670, filed May 13, 2004, the content of which is hereby incorporated by reference in its entirety.

### BACKGROUND OF THE INVENTION

The present invention relates to a user interface for displaying data to a user. More specifically, the present invention relates to a user interface for viewing and modifying data in a report in real time.

Businesses have typically used a variety of mechanisms to control and analyze business operations such as accounting, payroll, human resources, sale orders, employee tracking, customer relations tracking, etc. Tools that provide these functions are often implemented using computer software. A software package may provide a graphical user interface in order for a user to easily enter and view data corresponding to the various business operations. The graphical user interface provides the user with access to information stored in the database. The user can manipulate data as well as the presentation of the data (layout) with the interface.

Transactional data, employee data and customer data within business applications are generated and saved to a database for later retrieval, reporting and viewing. One common way for viewing and analyzing this data is through a report. Reports can be generated to provide a summary of data for analysis, such as customer address information, profit and loss data, sales data for a particular product, etc. Functionalities that enable easy viewing of reports and customization of reports are among a number of important features for business applications. However, viewing and customization of reports is currently quite cumbersome and time consuming for users of these business applications. The present invention provides easy access to the same base functionality found in current applications, but the invention provides a user interface with one access point to the report options usually found in multiple locations in the current applications.

### SUMMARY OF THE INVENTION

A computer-implemented method for presenting information to a user is provided. The method includes displaying a report having a plurality of groups representing the layout and filter options relevant to that specific report. Each group has a plurality of elements. A modification pane is displayed proximate the report display. The modification pane includes a plurality of modification options for layout and data filtering. A given selection of the report is associated with a selected group for which the invention provides the relevant modification options. This is the case with selections defined as headers, report data, etc. The method further includes changing how each of the _{[PB1]} plurality of elements in the selected group is displayed based on the selection.

A computer-readable medium is also provided including instructions for processing information. The instructions include a report viewer module adapted to display a report including a plurality of groups. Each group has an associated plurality of elements. A modification control module includes controls for selecting a group from the plurality of groups and modification options associated with the controls for changing how to display the plurality of elements associated with the selected group.

### BRIEF DESCRIPTION OF THE DRAWINGS

FIG. 1 is a block diagram of an exemplary computing system environment.

FIG. 2 is a block diagram of an exemplary report viewing environment.

FIG. 3 is a flow diagram of modules used for generating and modifying reports to be viewed.

FIG. 4 is a screenshot for use in generating a report.

FIG. 5 is a interface used for generating a report.

FIG. 6 is a block diagram of a report display and a modification pane.

FIG. 7 is a flow diagram of a method for modifying a report display.

FIGS. 8-15 are screenshots for use in modifying a report display.

### DETAILED DESCRIPTION OF ILLUSTRATIVE EMBODIMENTS

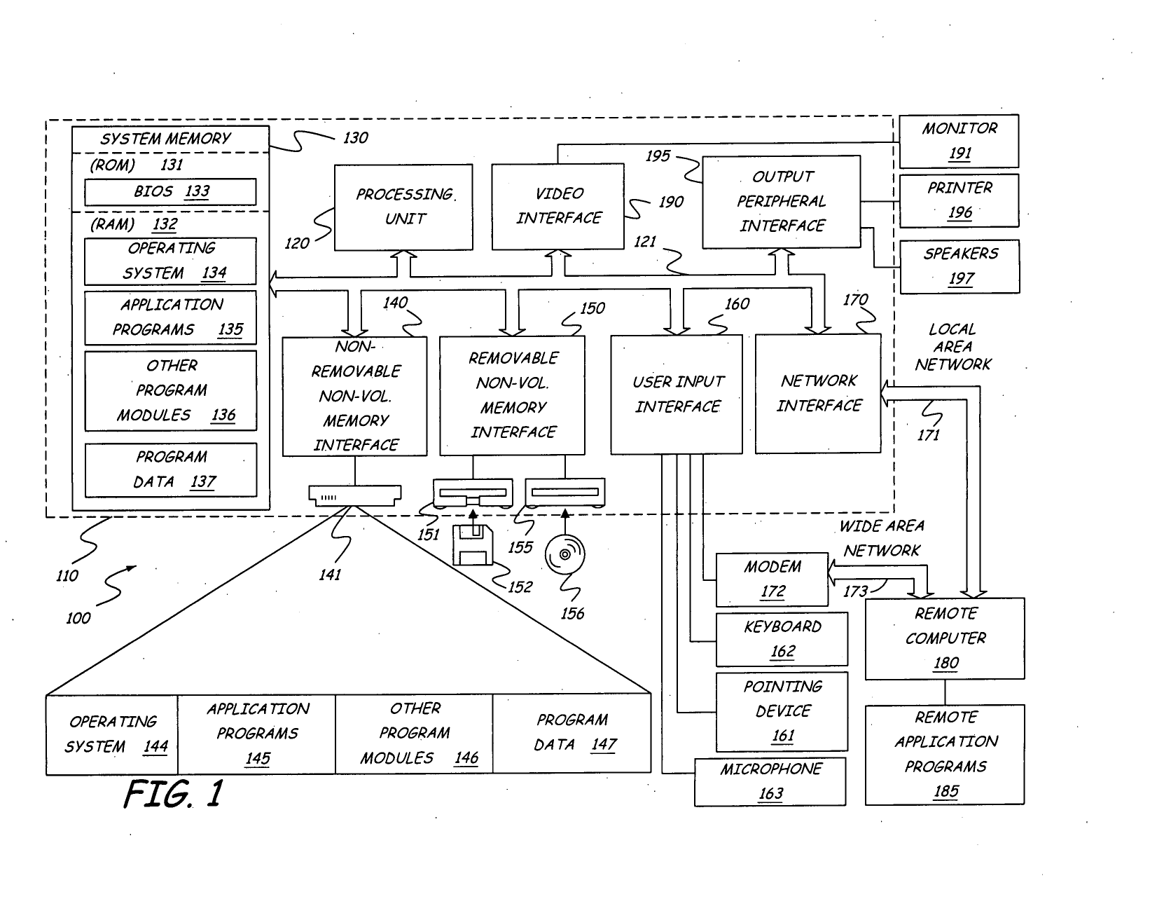

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. For natural user interface applications, a user may further communicate with the computer using speech, handwriting, gaze (eye movement), and other gestures. To facilitate a natural user interface, a computer may include microphones, writing pads, cameras, motion sensors, and other devices for capturing user gestures. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

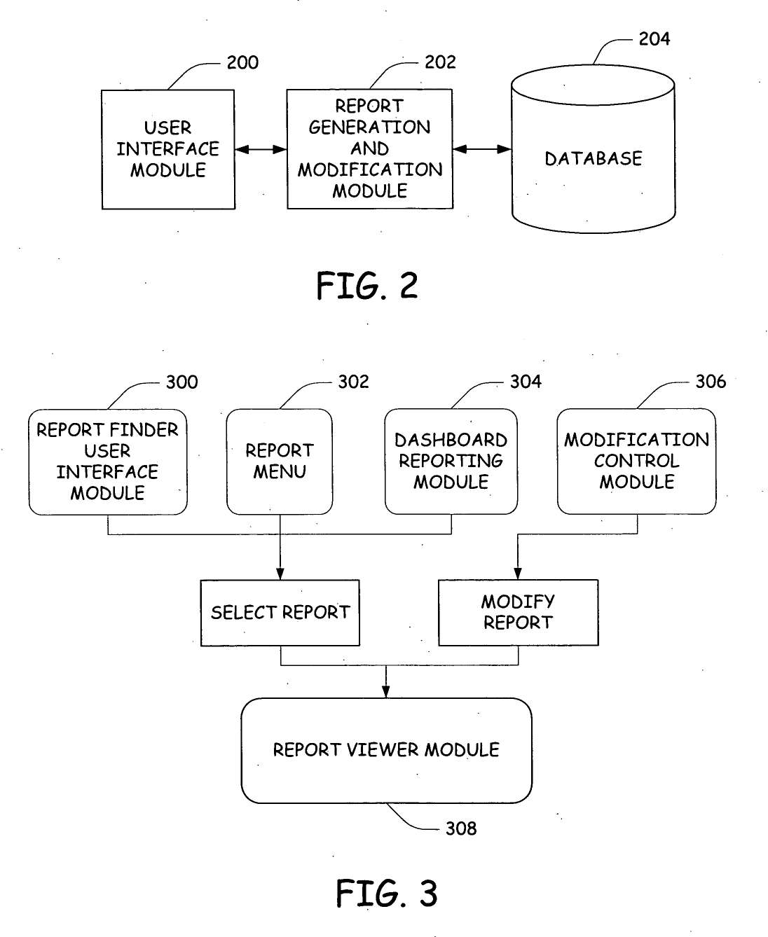

FIG. 2 is a simplified block diagram of an environment for report generation, editing and modification. A user interacts with a user interface module 200 in order to issue commands for generating, viewing and modifying reports. Commands received by the user interface module 200 are interpreted by a report generation and modification module 202. These commands can relate to applying filters to data, showing and hiding columns, modifying fonts and numbers, etc. Report generation and modification module 202 has access to a database 204 that includes business application data such as customer information, transaction data and employee information.

FIG. 3 is an exemplary flow diagram of a user interface to generate and modify reports. The flow diagram illustrates an exemplary implementation of user interface module 200 that operates with and provides commands to report generation and modification module 202 of FIG. 2. Within a business application, a report finder module 300, report menu 302 and dashboard recording module 304 can be used to generate a report. Additionally, a modification module 306 can be used to issue commands to modify a report. A report viewer module 308 displays the reports that are generated by report finder module 300, report menu 302 and dashboard reporting module 304. Additionally, report viewer module 308 renders reports after modification commands are received from modification module 306. In one embodiment, report viewer module 308 updates data and/or layout of a report in real time based on commands received from modification module 306.

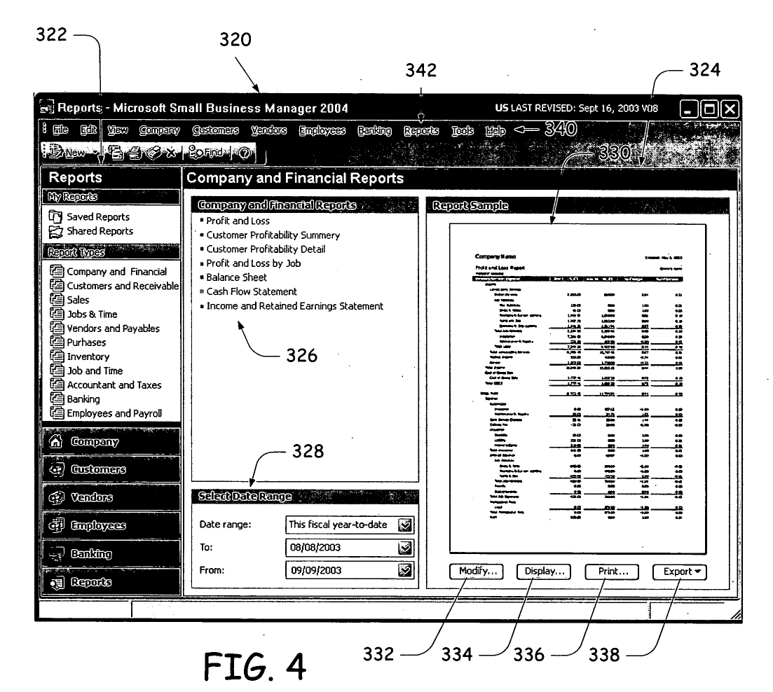

FIG. 4 is an exemplary screenshot of a user interface 320 of report finder module 300. User interface 320 includes a report type list 322 and a report type window 324 for which a user can select a report for generation. Report type list 322 includes a list of a plurality of report types such as company and financial, sales, purchases, employees and payroll, etc. A user can select one of the report types in report type list 322 to display selections in report type window 324. As illustrated, the user in this situation has selected the “company and financial reports” type from report type list 322 and thus report type window 324 includes selections for the types of reports related to company and financial reports.

Upon selection from the list 322, report type window 324 includes a report list 326, a date selection window 328 and a report preview 330. Report list 326 lists a plurality of choices for generating a company and financial report, for example reports related to profit and loss, balance sheet, cash flow statement, etc.

Date selection window 328 allows the user to select a particular date range for which to generate the report from report list 326. In one embodiment, the default date range is the fiscal year-to-date. Date selection window 328 includes pull-down menus for easy selection of the desired date range.

Report preview 330 shows a preview of the report to the user. A modify button 332, display button 334, print button 336 and export button 338 are also provided to perform functions on the report shown in report preview 330. Both the modified button 332 and display button 334 launch the report viewer module 308 of FIG. 3. Print button 336 prepares the report for printing and export button 338 exports the file to a Microsoft Excel file based on the XML format. Microsoft Excel is provided by Microsoft Corporation of Redmond, Wash.

Various menu items 340 are also displayed as part of report finder user interface 320. Menu items 340 can include a report menu 342 with various selections for generating a report and launching the report in report viewer module 308 (FIG. 3). For example, the selections can be similar to those presented in lists 322 and 326. Report menu 342 can be the same or similar to report menu 302 of FIG. 3.

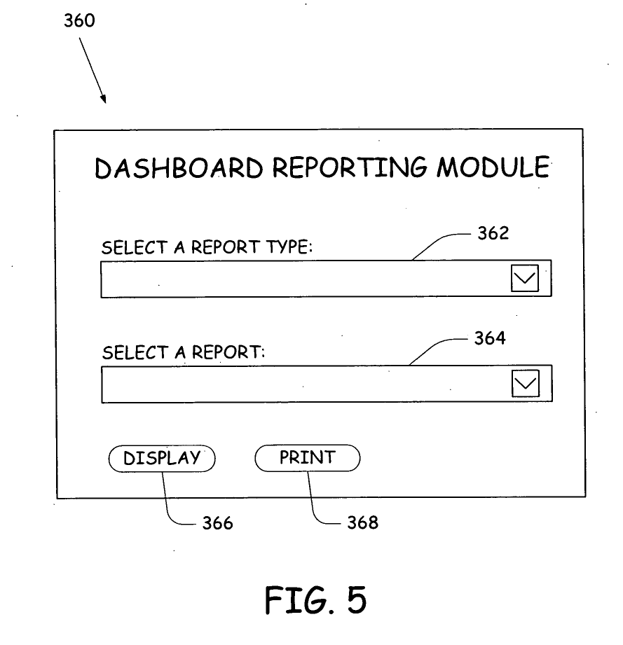

FIG. 5 illustrates a dashboard reporting user interface module 360 that can be utilized for quick access to reports within a business application. Interface 360 includes a report type selection menu 362 and report selection menu 364 for which a user may quickly and easily select a desired report to view. Menus 362 and 364 can include the same or similar selections to lists 322 and 326, respectively, as shown in FIG. 4. A display button 366 and print button 368 are further provided. Display button 366 launches report viewer module 308 with the report selected and print button 368 prints the report selected.

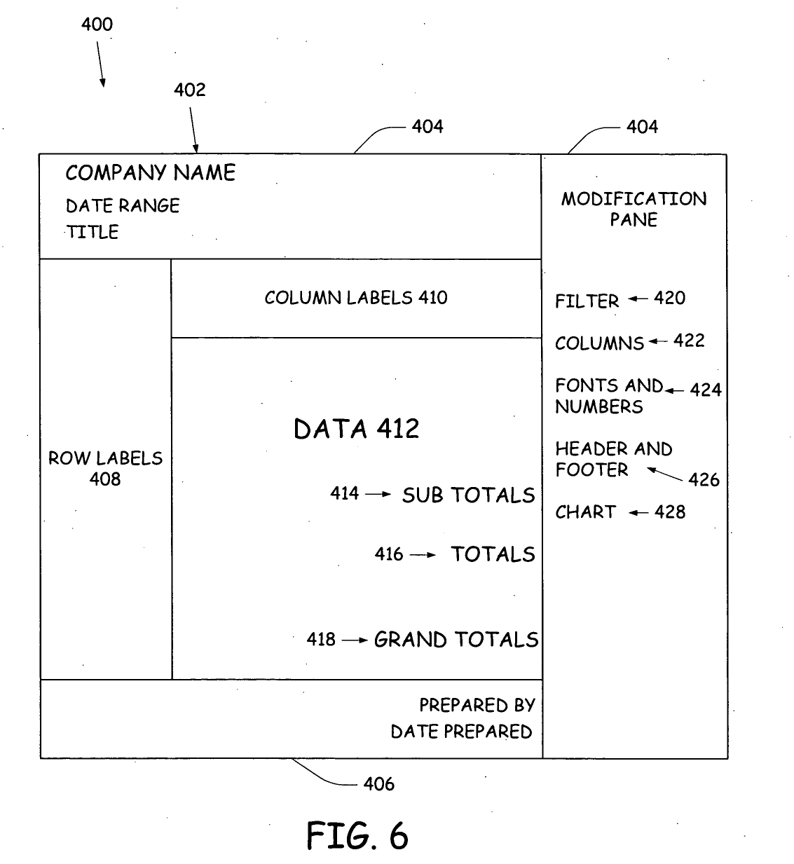

Once a report has been generated, report viewer module 308 and modification control module 306 are initiated. FIG. 6 illustrates a report viewer user interface 400 that can be used for viewing and editing reports upon initiating report viewer module 308 and modification control module 306. Interface 400 includes a report display 402 and a modification pane 404 in a single window. Report display 402 includes groups of elements that are common to reports. Selections (or options) in modification pane 404 can be utilized to modify the elements in a selected group in report display 402. The modification pane 404 is organized in a control tree to change how elements of the groups are rendered. For example, report display 402 can include groups related to a header 404 and footer 406 that identify elements in the report such as a company name, date range, report title, filter settings and date prepared. The report also includes groups related to row labels 408 and column labels 410. Data 412 is a group displayed with respect to the row labels 408 and column labels 410. Data 412 can include subgroups such as subtotals 414, totals 416 and grand totals 418.

Modification pane 404 includes several selections (or options) for modifying the elements of the groups in report display 402. By presenting modification pane 404 in the same window as report display 402, a user can easily select a group of the report to modify and details of the modification. For example, modification pane 404 can include selections related to filtering data, modifying columns, changing fonts, changing header/footer content and viewing charts.

In the embodiment illustrated, modification pane 404 includes several selectable items related to common report modification tasks to reduce the time in modifying reports to reader desired data in a desired format. Among the selections in pane 404 are filter control 420, column control 422, fonts and numbers control 424, header and footer control 426 and chart control 428. Each of these controls (420, 422, 424, 426, and 428) are associated with a particular group and can generate an associated list of options for modifying a selected group in report display 402. The selected group can be modified in real time to provide enhanced operation of interface 400.

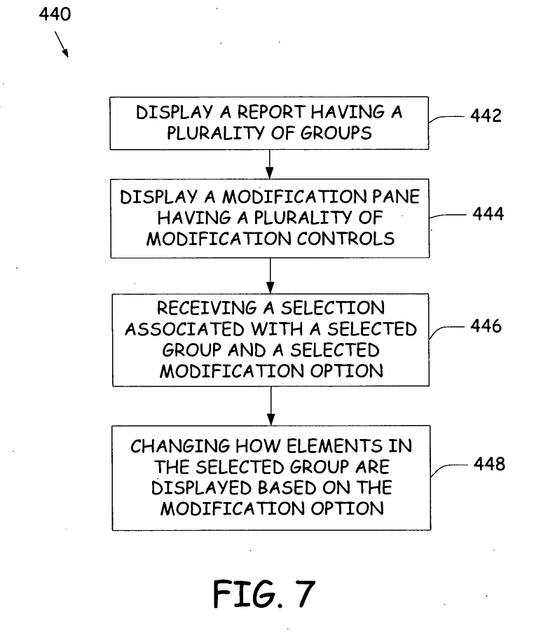

FIG. 7 is a flow diagram of a method 440 for modifying how information is displayed in report display 402. Method 440 begins at step 442 wherein a report having a plurality of groups is displayed. At step 444, a modification pane is displayed that includes a plurality of modification options. A selection associated with a selected group and a selected modification option is received at step 446. At step 448, how elements in the selected group are displayed is changed based on the selected modification option.

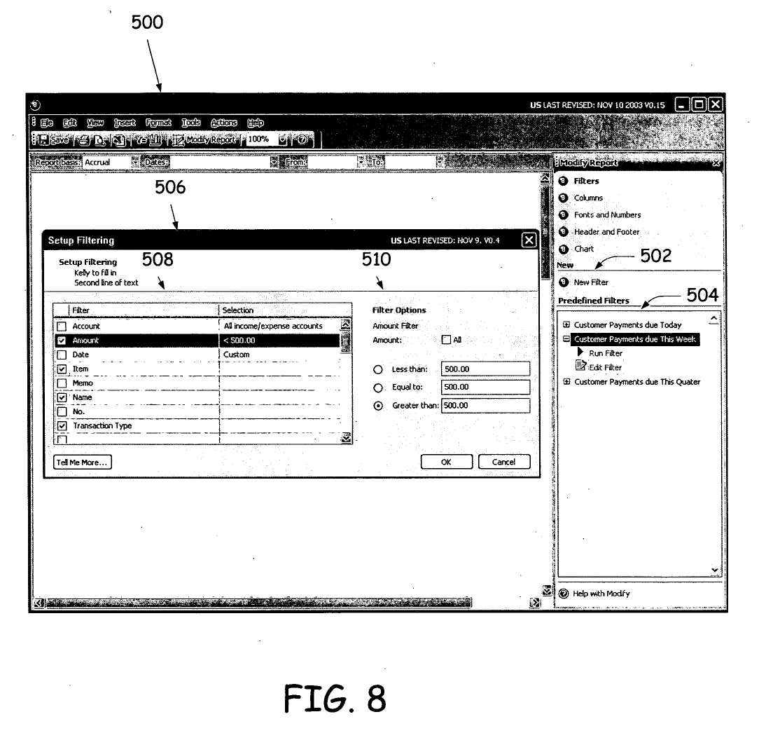

FIGS. 8-15 and associated discussion provided below describe operation of the controls illustrated in FIG. 6 and the method of FIG. 7 through screenshots of report viewer module 308. Each of the screenshots include a report display for modification and an associated modification pane similar to interface 400 of FIG. 6. The options provide an enhanced user experience with regards to modifying and analyzing report data and thus provide an effective reporting tool.

FIG. 8 is an exemplary screenshot 500 for operation of filter control 420 of FIG. 6. Filter control 420 is associated with what particular report data 412 to display. Screenshot 500 includes a new filter option 502 and a option list of predefined filters 504. New filter option 502 can be used to generate a new filter for a report. Predefined filter list 504 includes a plurality of filters that are used for a particular report. For example, list 504 includes filters related to due dates of customer payments. The items in list 504 include collapsible menu items and options to run or edit a particular filter. A filtering setup window 506 is generated that includes filtering parameters 508 as well as filter options 510 associated with a particular filtering parameter 508. For example, the filtering parameters 508 can relate to an account, amount, date, item, name, etc. As illustrated, filter options 510 include selections for filtering a particular amount, such as customer payments with an amount greater than (for example) $500. After filtering parameters 508 and filter options 510 are selected, an associated report is automatically modified within screenshot 500.

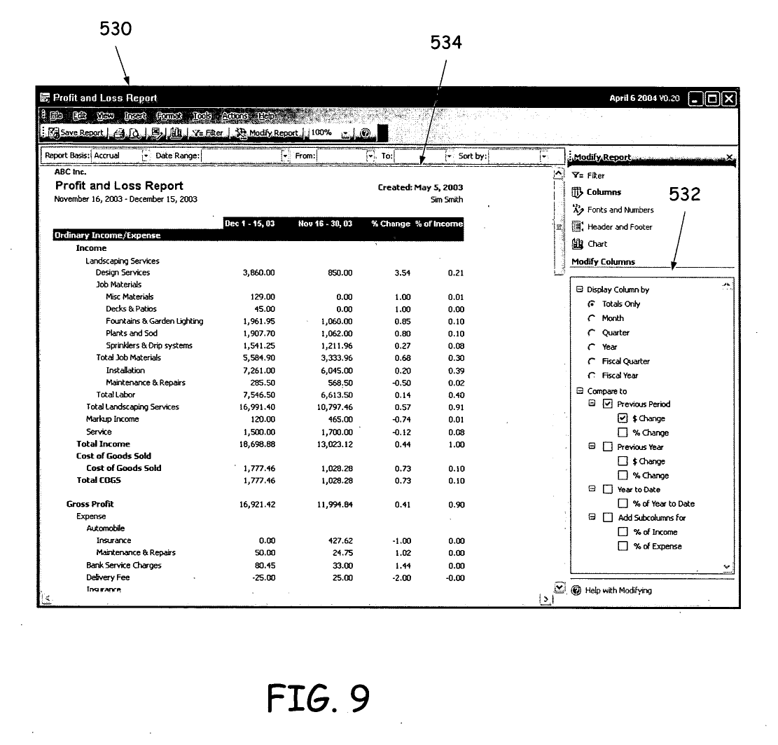

FIG. 9 is a screenshot 530 that includes a modified columns option list 532 and associated report 534 for operation of column control 422 of FIG. 6. In list 532, a user can select to display a column by a particular period such as a month, quarter or year and/or display just the totals, for example total 416 of FIG. 6. Furthermore, a user can display columns for comparison to a previous period and display a dollar change column and/or percentage change column from the previous period. Once a particular selection is made in list 532, report 534 is automatically modified without the need to generate a new report or window for the report display. Thus, a real time update of data in the report is provided.

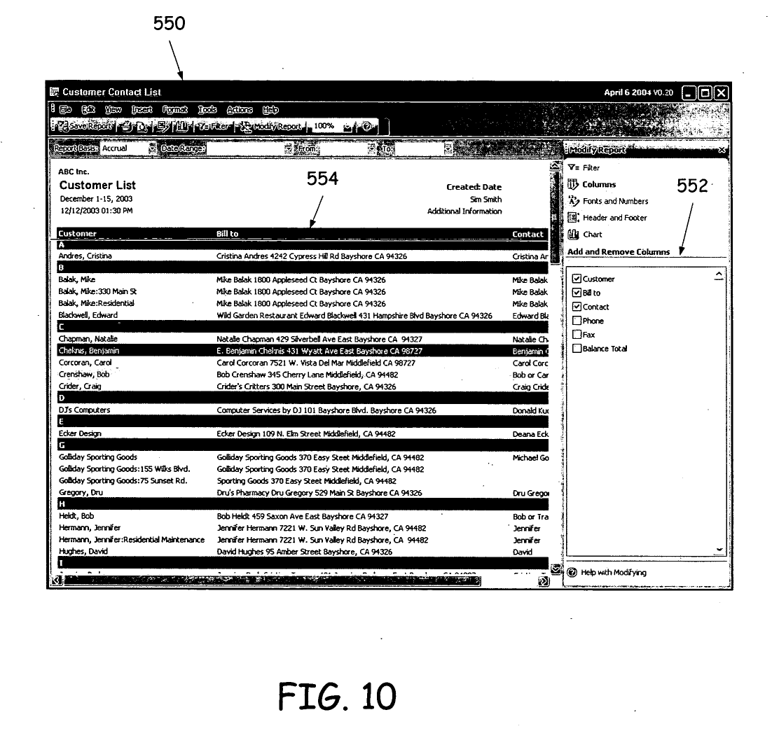

In FIG. 10, a screenshot 550 is shown that includes a column option list 552 and report 554 for an alternative column control 422 of FIG. 6. List 552 includes check boxes for adding or removing columns from report 554. Upon selection or de-selection of any of the items in list 552, report 554 is automatically updated without the need to generate a new report. In particular, the selections in list 552 provide real-time updating of report 554 in a user-friendly manner.

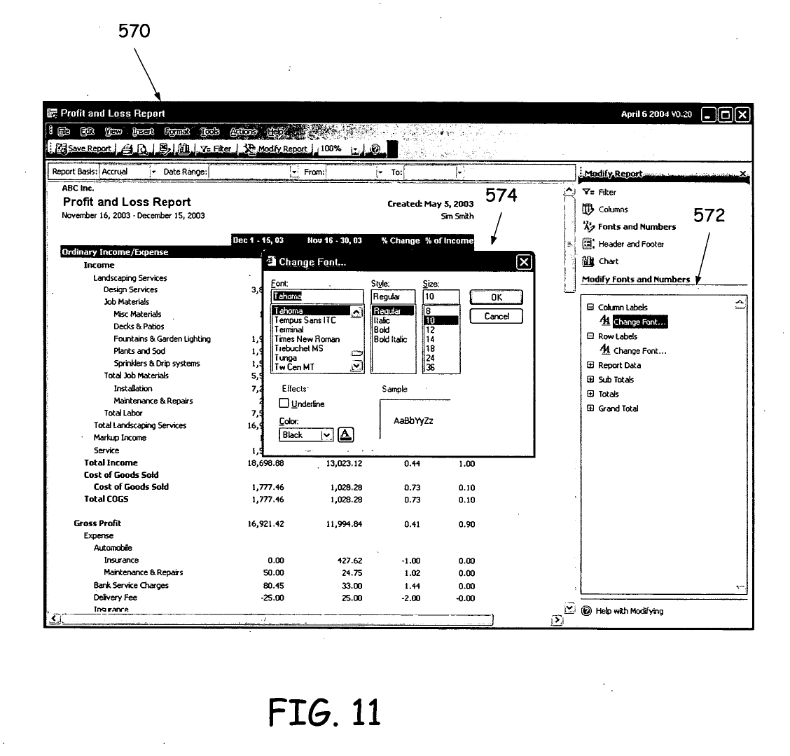

FIGS. 11-14 illustrate exemplary screenshots for modifying fonts and numbers of groups within a report, such as row labels 408, column labels 410 and data 412 of FIG. 6. Upon choosing control 424 a list of options is generated that includes options associated with the groups. Each of the screenshots illustrated in FIGS. 11-14 include an associated modified fonts and numbers option list that are used to modify all of the elements of a selected group.

FIG. 11 is a screenshot 570 including a modify option list 572. In screenshot 570, the font of the column labels has been selected to be changed. A corresponding font modification window 574 is generated for easy selection by a user to modify the font of the column labels contained in an associated report. As illustrated, font modification window 574 includes a font selection, style selection, size selection, effects selection and color selection. Upon choosing the particular selections, elements in the associated report (in this case all of the elements in the column labels group) are updated with the same font.

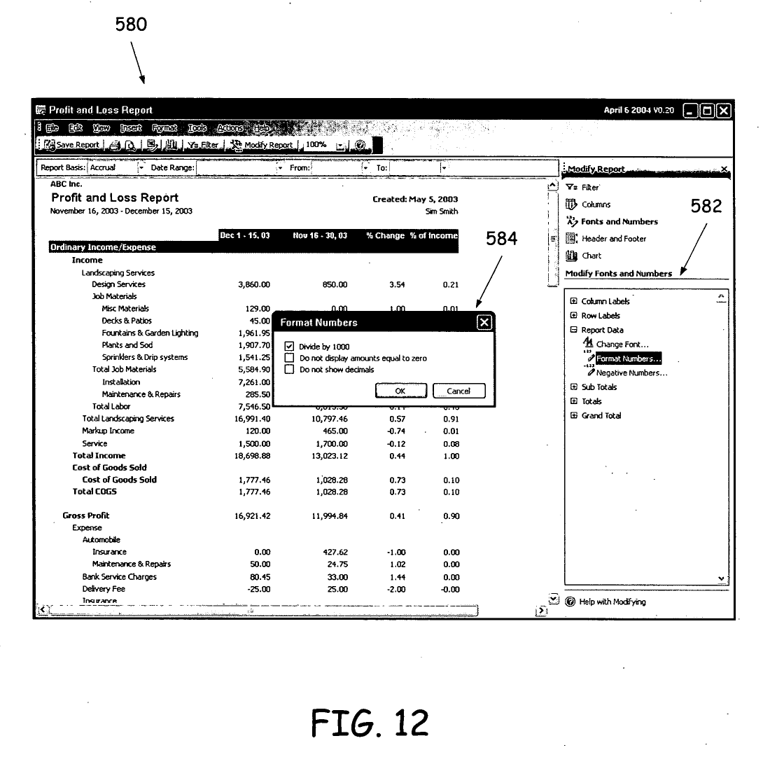

FIG. 12 illustrates a screenshot 580 including a modify option list 582. In screenshot 580, a user desires to format numbers in the report data, such as report data 412 of FIG. 6. Upon selection from list 582, an associated format window 584 is displayed to the user. Window 584 includes selections for dividing report data by 1000, displaying amounts equal to zero and display of decimals. All report data is modified according to the format selections.

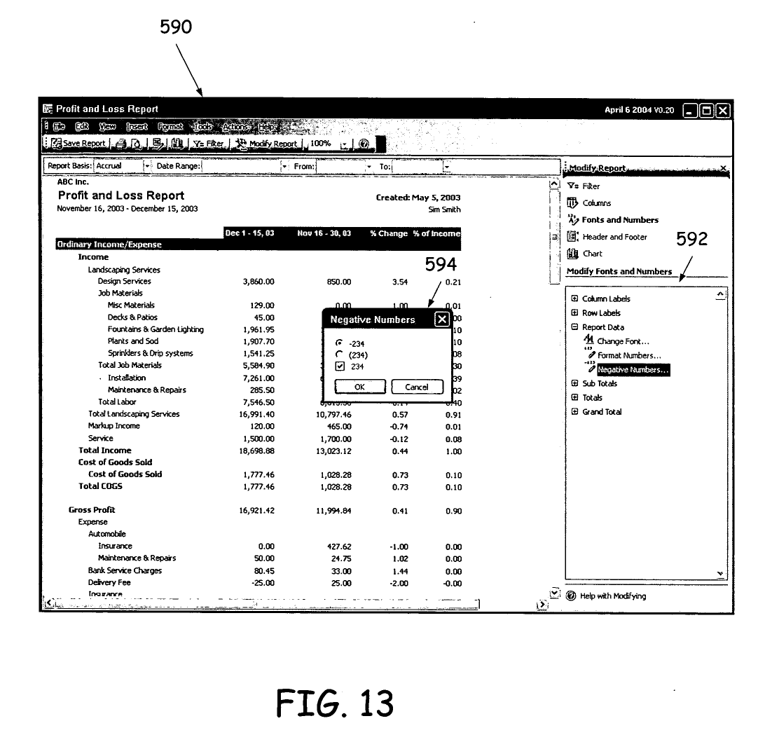

FIG. 13 is a similar screenshot 590 having a modify option list 592. In screenshot 590, a user has chosen to modify how negative numbers in the report data are displayed within an associated report. A corresponding negative numbers display window 594 is presented to the user. Window 594 includes selections relating to displaying a minus sign in front of negative numbers, placing parentheses around negative numbers and choosing to display numbers in a particular color, such as red. All numbers in the report data are automatically updated upon selection of a particular format.

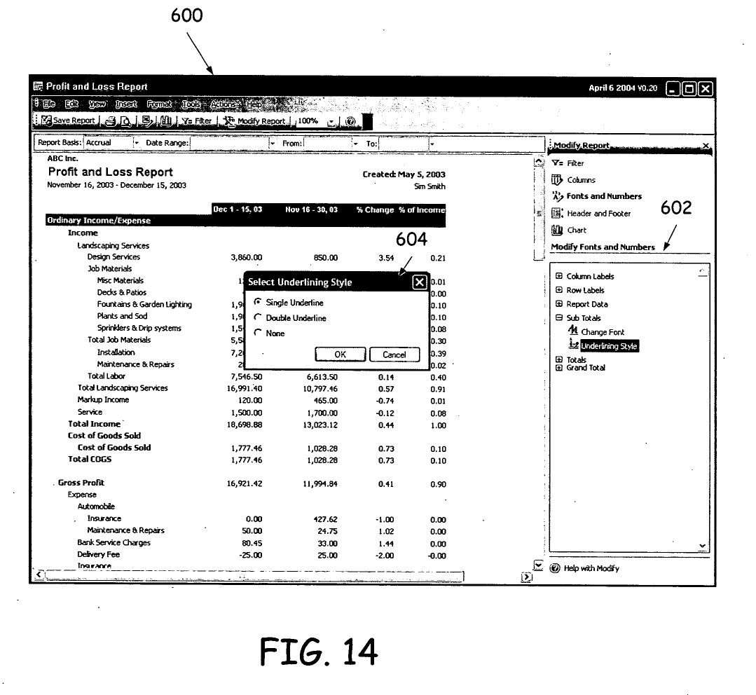

FIG. 14 is a screenshot 600 including a modify option list 602. In screenshot 600, the user has chosen to modify the underline style for subtotals in a report. An associated window 604 is displayed to the user that presents selectable options related to a single underline, a double underline or no underline for subtotals in the report. Upon selection of one of the options in window 604, the subtotals of the associated report are modified according to the selected underline format.

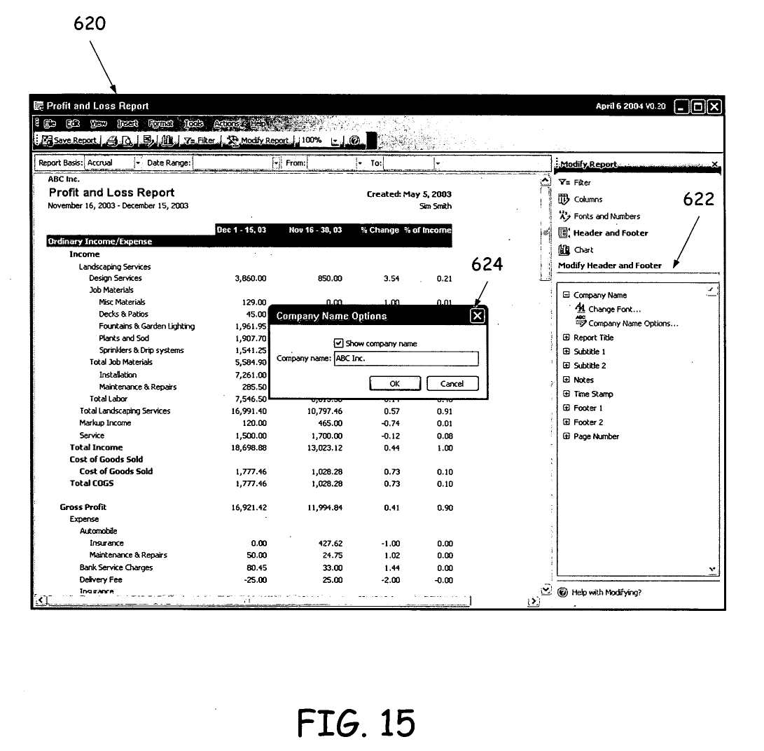

FIG. 15 is a exemplary screenshot 620 for modifying a header and footer of a report including operation of header and footer control 426 of FIG. 6. Screenshot 620 includes a modify option list 622. List 622 includes various elements that are common to a header and/or footer such as company name, report title, subtitles, notes, page number, etc. Upon selection of one of the elements in list 622, an associated window 624 can be generated. In screenshot 620, a user has selected the company name options modification. Window 624 includes a selection box related to whether a name of the company for the report shall be shown and a text box for inserting the name of the company. Upon selection of the options in window 624, an associated report is automatically modified.

Using embodiments of the present invention described above, user-friendly report modification controls can reduce the difficulty and time in generating and modifying reports. The modification controls described herein provide an easy way to customize a report for analysis, viewing, printing and exporting to different file types. Additionally, selected groups of the report can be updated in real time to enhance user operation.

Although the present invention has been described with reference to particular embodiments, workers skilled in the art will recognize that changes may be made in form and detail without departing from the spirit and scope of the invention.

1. A computer-implemented method for presenting information to a user, comprising:
displaying a report having a plurality of groups in a report display, each group having a plurality of elements;
displaying a modification pane proximate the report display, the modification pane including a plurality of modification options;
receiving a selection associated with a selected group and a selected modification option; and
changing how each of the plurality of elements in the selected group is displayed based on the selection.

2. The method of claim 1 wherein the plurality of elements in the selected group is report data associated with the report and the selected modification option includes filtering the report data.

3. The method of claim 2 wherein filtering relates to a numerical value for the report data.

4. The method of claim 2 wherein filtering relates to a date for the report data.

5. The method of claim 1 wherein the plurality of elements in the selected group includes elements in a column associated with the report and the selected modification option includes adding the column to the report display or removing the column from the report display.

6. The method of claim 1 wherein the plurality of elements in the selected group includes a first column of report data from a first period and a second column of report data from a second period and the selected modification option includes displaying a percentage change column or a value change column as a function of a difference in values between the first column and the second column.

7. The method of claim 1 wherein the plurality of elements in the selected group is at least one of column labels, row labels and report data and the selected modification option includes changing the font of text in the selected group.

8. The method of claim 1 wherein the plurality of elements in the selected group includes numbers in report data of the report and the selected modification option includes formatting the numbers.

9. The method of claim 1 wherein the plurality of elements in the selected group includes at least one of a header and a footer and the selected modification option includes altering content of the selected group.

10. A computer-readable medium including instructions for processing information, comprising:
a report viewer module adapted to display a report including a plurality of groups, each group having an associated plurality of elements; and
a modification control module including controls for selecting a group from the plurality of groups and modification options associated with the controls for changing how to display the plurality of elements associated with the selected group.

11. The method of claim 10 wherein the modification control module includes a filter control adapted to filter report data of a selected group based on a filter modification option.

12. The method of claim 11 wherein the filter control is adapted to filter report data based on a numerical value for the report data.

13. The method of claim 11 wherein the filter control is adapted to filter report data based on a date for the report data.

14. The method of claim 10 wherein the modification control module includes a column control adapted to display or remove columns from the report.

15. The method of claim 14 wherein the column control is further adapted to display at least one of a percentage change column and a value change column based on a difference of two associated columns.

16. The method of claim 10 wherein the modification control module includes a font control adapted to change a font for at least one of column labels, row labels and report data associated with the report.

17. The method of claim 10 wherein the modification control module includes a number control adapted to change a format of a numbers in report data of the report.

18. The method of claim 10 wherein modification control module includes a header and footer control adapted to alter content of at least one of a header and a footer associated with the report.
